(19) United States
(12) Patent Application Publication
(10) Pub. No.: US 2024/0093040 A1
(43) Pub. Date: Mar. 21, 2024

(54) MULTILAYER POLYMER COMPOSITES FOR SEALING CONCRETE SURFACES

(71) Applicant: Saudi Arabian Oil Company, Dhahran (SA)

(72) Inventors: Mahmoud A. Dweib, Dhahran (SA); Emad Abu-Aisheh, Melbourne (AU)

(21) Appl. No.: 17/948,888

(22) Filed: Sep. 20, 2022

(51) Int. Cl. C09D 5/16; C09D 7/40; C09D 7/61; C09D 163/00; C09D 175/04

(52) U.S. Cl. CPC C09D 5/1693; C09D 5/1662; C09D 5/1687; C09D 7/61; C09D 7/69; C09D 163/00; C09D 175/04

(57) ABSTRACT

Systems and methods for sealing concrete are provided. An exemplary multilayer concrete sealant includes a first layer disposed over a concrete surface, wherein the first layer includes an epoxy nanocomposite, and a second layer disposed over the epoxy nanocomposite, wherein the second layer includes a polyurethane microcomposite.

### TECHNICAL FIELD

The present disclosure is directed to multilayer polymer composites used to seal concrete surfaces.

### BACKGROUND

Reinforced concrete construction is often subjected to severe conditions, especially in marine environments, such as the Arabian Gulf region. Combinations of salt, moisture, and heat make the reinforced concrete particularly vulnerable to deterioration and possible failure. The main factor affecting the durability of reinforced concrete structures is the corrosion of the steel reinforcement from chlorides, especially at elevated temperatures. For example, concrete that is directly exposed to marine environments, such as berths, docks, seawalls, slabs on grade, and industrial cooling tower basins suffer from accelerated corrosion due to the ingress of the chloride ions into the concrete causing reinforcement corrosion that leads to cracking and spalling of the concrete surfaces.

Concrete is produced as a dry mixture of cement, sand, and stone. After the addition of water, the cement chemically reacts and forms a paste that binds the sand and stone together. As the concrete dries, hardens, and cures, water migrates out in a process called bleeding and evaporates. The evaporated water leaves behind a network of pores in the concrete, often making up 10% to 15% of the volume of the concrete. The pores and interconnected internal cracks allow water to migrate back into the concrete, allowing chloride ions to reach the steel reinforcing structures, causing corrosion. The corrosion, or rust, generally has a higher volume (6 to 8 time the volume of reinforcing steel) and the steel reinforcing structures themselves, and the expansion leads to cracking, spalling, and breaking of the concrete.

Surface protection coatings, such as sealants, are often used to protect concrete from exposure to harsh environments. However, many types of sealants are vulnerable to ultraviolet degradation. Further, sealants available in the market are generally not able to penetrate into the concrete pores to seal them. In addition, most sealants and waterproofing membranes are not designed for vehicular or machine traffic on top of them. Thus, there is no reliable protection method for concrete platforms and structures that is designed for heavy traffic in aggressive marine environments.

### SUMMARY

An embodiment described herein provides a method for sealing concrete. The method includes applying an activated epoxy nanocomposite to a concrete surface to form a sealant layer, and applying a polyurethane-composite reaction mixture over the sealant layer to form a top layer.

Another embodiment described herein provides a multilayer concrete sealant. The sealant includes a first layer disposed over a concrete surface, wherein the first layer includes an epoxy nanocomposite, and a second layer disposed over the epoxy nanocomposite, wherein the second layer includes a polyurethane microcomposite.

### BRIEF DESCRIPTION OF DRAWINGS

FIGS. 1A and 1B are drawings showing examples of cracks in concrete on the top of a slab surface and on a soffit below a slab surface.

FIGS. 2A and 2B are drawings showing examples of broken concrete surfaces resulting from water infiltration.

FIG. 3 is a schematic drawing of a two-layer sealant over a concrete slab.

FIG. 4 is a process flow diagram of a method for sealing concrete with a multilayer sealant including polymer composites.

FIG. 5 is a process flow diagram of a method for forming a multilayer sealant and sealing concrete with the multilayer sealant.

### DETAILED DESCRIPTION

A multilayer, reinforced-composite sealant system for concrete is provided herein. The sealant system includes two layers, a first layer in direct contact with a concrete surface, wherein the first layer includes an epoxy resin that is reinforced with nanoparticles. The epoxy resin is selected to have a low viscosity prior to curing to enable flow into cracks, surface voids, and pores in the concrete, to prevent the ingress of water, chemicals, or gases that might attack and corrode the steel reinforcing structures (rebar).

One or more additional layers are applied over the first layer, wherein the additional layers include a polyurethane resin that is reinforced with microparticles. In addition to strengthening the polyurethane, and providing some protection from UV degradation, the larger microparticles provide a surface roughness that improves traction for vehicular traffic.

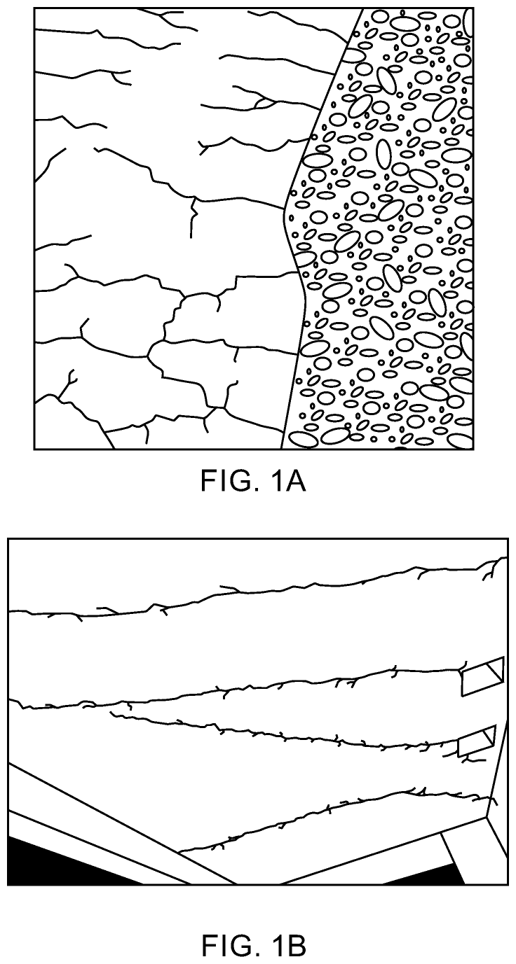

FIGS. 1A and 1B are drawings showing examples of cracks in concrete on the top of a slab surface and on a soffit below a slab surface. The cracks in the concrete surface can form for any number of reasons including, for example, settling, wear, and environmental exposure, among others. For example, as discussed herein, water can infiltrate the concrete surface and initiate corrosion of the rebar, which may lead to the formation of higher volume corrosion products that add tensile pressure to the concrete causing cracking. In some cases, water may splash over or remain on the surface over time, enhancing the infiltration. Similarly, concrete surfaces that are formed then immersed in seawater, such as docks or berths, among others, may have severe corrosion issues under the surface of the water.

Over time, the water infiltration into the pores and cracks of the concrete can lead to spalling, which is the flaking of large concrete chunks. This is a progressive problem, which accelerates as the concrete degrades.

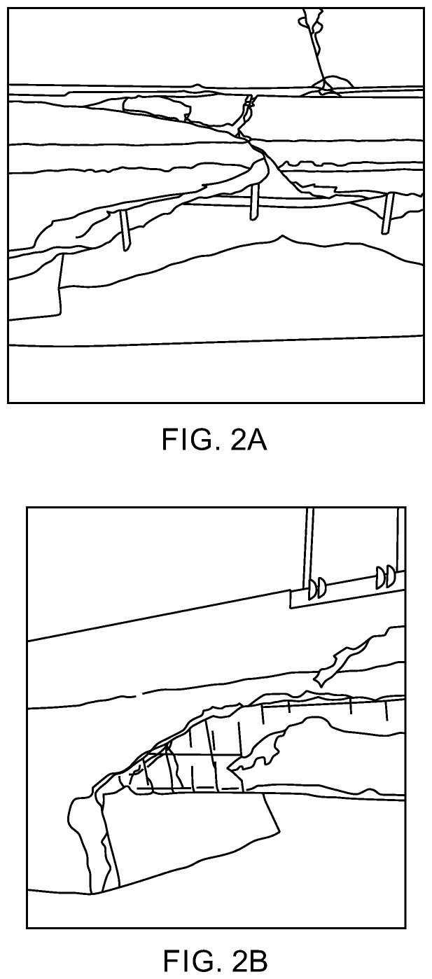

FIGS. 2A and 2B are drawings showing examples of broken concrete surfaces resulting from water infiltration. Unprotected concrete surfaces, and untreated cracks, can lead to failure of the surfaces as shown in FIGS. 2A and 2B. Over time, these types of failures can lead to complete failures of the structures.

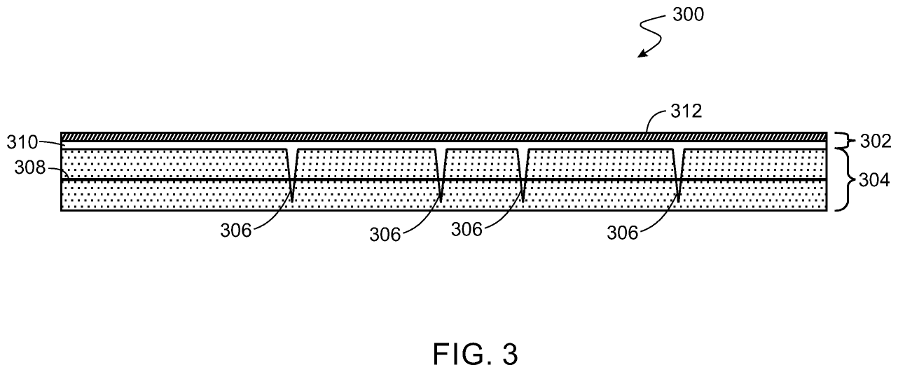

FIG. 3 is a schematic drawing 300 of a two-layer sealant 302 that is applied over a concrete slab 304. As shown in the schematic drawing 300, cracks 306 in the concrete slab 304 can reach to the rebar 308, allowing corrosion that could cause spalling.

The first layer 310, which is in direct contact with the concrete slab 304, includes an epoxy resin reinforced with nanoparticles, termed an epoxy nanocomposite. Prior to curing, the epoxy resin is a low viscosity liquid that can penetrate the cracks 306 and pores of the concrete slab 304. For example, the liquid epoxy may penetrate microcracks and pores that are less than 30 μm in size. These microcracks and pores are large enough to allow water infiltration, but are too small to allow many current types of sealants to penetrate. In various embodiments, the epoxy nanocomposite comprises less than about 5 wt. % of nanoparticles, or between about 1 and about 4 wt. %.

In some embodiments, the nanoparticles are silicon dioxide with a size distribution of between about 10 nm and about 500 nm. Depending on the strength requirements, other types of nanoparticles may be used, including silicon nitride, silicon carbide, and the like. The smaller nanoparticles can be carried into the pores of the concrete slab 304 with the liquid epoxy, while both the smaller and larger nanoparticles can be carried into cracks 306 with the liquid epoxy. After curing, the epoxy nanocomposite in the first layer 310 seals the cracks 306 and pores to prevent penetration of water, chemicals, or gas protecting the rebar 308 from new or further corrosion. The first layer 310 is less than about 1 mm in thickness, or between about 0.25 mm and about 0.75 mm thick. Of course, higher thicknesses are present in cracks and surface voids.

A second layer 312 is applied over the epoxy nanocomposite. In some embodiments, the epoxy nanocomposite is allowed to cure before the second layer 312 is applied. In other embodiments, the epoxy nanocomposite may be partially cured before applying the second layer 312 to increase the bonding between the second layer 312 and the first layer 310, for example, by the formation of chemical bonds between the first layer 310 and the second layer 312.

The second layer 312 is a polyurethane resin that is reinforced with microparticles. In some embodiments, the microparticles include powdered basalt with a size range of between about 50 μm and 100 μm. In some embodiments, the microparticles are present at between about 3 wt. % and about 20 wt. % of the second layer 312. Other types of powders may be used, including, for example, silicon dioxide, or combinations of silicon dioxide with carbon black. The use of the microparticles provides an enhanced resistance to ultraviolet (UV) light, protecting both the second layer 312 and the first layer 310. Further, the larger particle size provides an anti-slipping surface, and abrasion resistance that allows vehicle and heavy equipment movement while protecting the surface and sealant.

The second layer 312 is applied at a thickness of about 1 mm to about 2 mm. Multiple layers may be applied to reach this thickness, wherein each layer is allowed to cure before the next layer is applied.

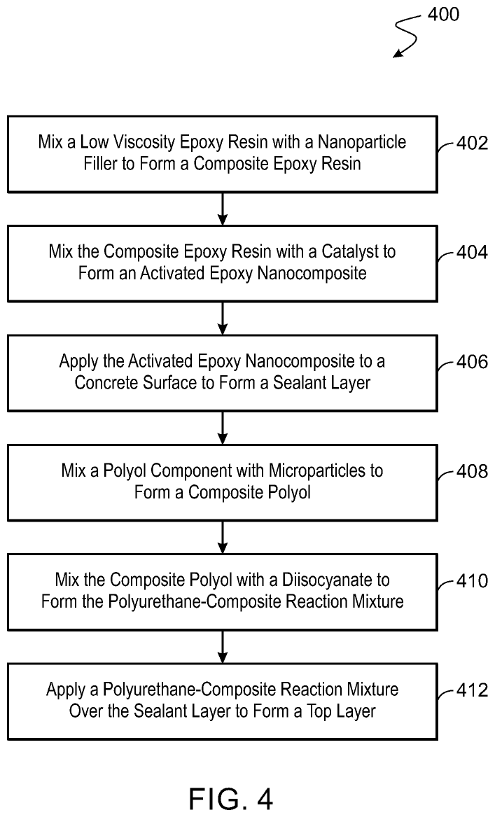

FIG. 4 is a process flow diagram of a method 400 for forming a multilayer sealant and sealing a concrete surface with the multilayer sealant. The method begins at block 402, with the mixture of a low-viscosity epoxy resin and a nanoparticle filler to form a composite epoxy resin. The low-viscosity epoxy resin is available from a number of sources, for example as the bisphenol F grade from Thermal-Chem Corporation of Broadview, IL, USA. Similar materials are available from Olin Epoxy, of Houston, TX, USA. In some embodiments, the nanoparticle filler is silicon dioxide available as silicon oxide nanopowder from American Elements of Los Angeles, CA, USA. Similar materials are available from Nanostructure and Amorphous Materials, Inc. of Katy, TX, USA. The nanoparticles are blended in with the low-viscosity epoxy formulation to form a final nanoparticle content of less than about 5 wt. %

At block 404, the composite epoxy resin is blended with a catalyst to form an activated epoxy nanocomposite. The catalyst may be a polyamide, a modified polyamide, or other amine curing agent, for example, available from Olin Epoxy. As the catalyst will start the cure, application to the concrete surface must be performed within a few minutes after the mixing.

At block 406, the activated epoxy nanocomposite is applied to a concrete surface to form a sealant layer. In some embodiments, the activated epoxy nanocomposite is sprayed on the concrete surface. The sprayer may include a mixer that incorporates the catalyst into the liquid epoxy as it is being sprayed. This may allow for the application to larger surface areas. The activated epoxy nanocomposite may be applied with other techniques, such as a brush or a roller. The layer of the activated epoxy nanocomposite will be applied at less than about 1 mm, or between about 0.25 mm and about 0.75.

At block 408, a polyol component of a polyurethane is blended with microparticles to form a composite polyol. The polyol can be a high viscosity polyol, for example, available for Vertellus of Indianapolis, IN, USA. In some embodiments, the microparticles are basalt, such as basalt dust, available from Kremer Pigments, Inc. of New York City, NY, USA. The basalt dust is blended into the polyurethane polyol at about 3 wt. % to about 20 wt. %, or about 10 wt. %. In some embodiments, the basalt dust has a size range of about 1-100 μm and average particle size of 20 μm.

At block 410, the composite polyol is blended with a diisocyanate to form a polyurethane-composite reaction mixture. The diisocyanate can include an aliphatic diisocyanate, such as 1,6-hexamethylene diisocyanate (HDI), 1-isocyanato-3-isocyanatomethyl-3,5,5-trimethyl-cyclohexane (isophorone diisocyanate, IPDI), and 4,4′-diisocyanato dicyclohexylmethane (H12MDI or hydrogenated MDI), or any number of other diisocyanates that are commercially available, for example, from Dow Chemical of Midland, MI, USA, among others. The use of an aliphatic isocyanate increases the light stability. However, aromatic diisocyanates, such as methyl diphenyl diisocyanate (MDI) or 2,4-toluene diisocyanate (TDI) can be used under lower light conditions. A catalyst can be added to accelerate the curing reaction, control side reactions, such as foaming, and the like. In some embodiments, dibutyltin dilaurate, available from American Elements, among others.

At block 412, the polyurethane-composite reaction mixture is applied to the concrete surface over the epoxy sealant to form a second layer. This may be performed using a roller, doctor blade, brush, or sprayer. In some embodiments, a sprayer with a mixing head is used to mix and apply the polyurethane-composite reaction mixture. The polyurethane-composite reaction mixture is applied to form a layer between about 1 mm and 2 mm, or about 1.5 mm. In some embodiments, Thinner layers, such as about 0.25 mm, are sequentially applied to reach a final thickness.

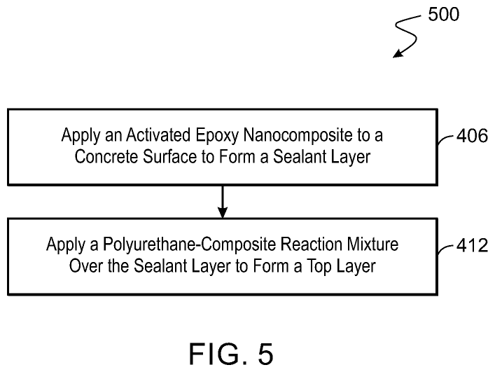

FIG. 5 is a process flow diagram of a method 500 for sealing concrete with a multilayer sealant including polymer composites. Like numbered items are as described with respect to FIG. 4. As described herein, at block 406, an activated epoxy nanocomposite is applied to a concrete surface to form a sealant layer. This is followed at block 412, with the application of a polyurethane-composite reaction mixture to the concrete surface over the epoxy sealant.

### Embodiments

An embodiment described herein provides a method for sealing concrete. The method includes applying an activated epoxy nanocomposite to a concrete surface to form a sealant layer, and applying a polyurethane-composite reaction mixture over the sealant layer to form a top layer.

In an aspect, the method includes mixing a low viscosity epoxy resin with a nanoparticle filler to form a composite epoxy resin, and mixing the composite epoxy resin with a catalyst to form the activated epoxy nanocomposite. In an aspect, less than 5 wt. % of the nanoparticle filler with the epoxy to form the composite epoxy resin.

In an aspect, the method includes applying the activated epoxy nanocomposite with a sprayer. In an aspect, the method includes applying the activated epoxy nanocomposite with a brush or a roller. In an aspect, the method includes applying the activated epoxy nanocomposite to fill cracks and surface voids. In an aspect, the method includes applying the activated epoxy composite at a thickness of less than 1 mm. In an aspect, the method includes allowing the activated epoxy nanocomposite to set before applying another layer.

In an aspect, the method includes mixing a polyol component with microparticles to form a composite polyol, and mixing the composite polyol with a diisocyanate to form the polyurethane-composite reaction mixture. In an aspect, the method includes mixing about 3 to about 20 wt. % of the basalt particles with the polyol component to form the composite polyol.

In an aspect, the method includes applying the polyurethane-composite reaction mixture with a sprayer. In an aspect, the method includes applying the polyurethane-composite reaction mixture with a doctor blade. In an aspect, the method includes applying the polyurethane-composite reaction mixture at a thickness of about 1 mm to about 2 mm. In an aspect, the method includes applying multiple layers of the polyurethane-composite reaction mixture over the activated epoxy nanocomposite, allowing each layer to set before applying another layer to reach a thickness of about 1 mm to about 2 mm.

Another embodiment described herein provides a multilayer concrete sealant. The sealant includes a first layer disposed over a concrete surface, wherein the first layer includes an epoxy nanocomposite, and a second layer disposed over the epoxy nanocomposite, wherein the second layer includes a polyurethane microcomposite.

In an aspect, the epoxy nanocomposite includes less than about 5 wt. % of nanoparticles. In an aspect, the nanoparticles include silicon dioxide. In an aspect, the nanoparticles are between about 10 nm and about 500 nm in size.

In an aspect, the polyurethane microcomposite includes between about 3 wt. % and about 20 wt. % of microparticles. In an aspect, the microparticles include basalt. In an aspect, the microparticles are between about 1 and 100 μm. In an aspect, the microparticles have an average particle size of 20 μm.

Other implementations are also within the scope of the following claims.

What is claimed is:

1. A method for sealing concrete, comprising:
applying an activated epoxy nanocomposite to a concrete surface to form a sealant layer; and
applying a polyurethane-composite reaction mixture over the sealant layer to form a top layer.

2. The method of claim 1, comprising:
mixing a low viscosity epoxy resin with a nanoparticle filler to form a composite epoxy resin; and
mixing the composite epoxy resin with a catalyst to form the activated epoxy nanocomposite.

3. The method of claim 2, comprising mixing less than 5 wt. % of the nanoparticle filler with the epoxy to form the composite epoxy resin.

4. The method of claim 1, comprising applying the activated epoxy nanocomposite with a sprayer.

5. The method of claim 1, comprising applying the activated epoxy nanocomposite with a brush or a roller.

6. The method of claim 1, comprising applying the activated epoxy nanocomposite to fill cracks and surface voids.

7. The method of claim 1, comprising applying the activated epoxy composite at a thickness of less than 1 mm.

8. The method of claim 1, comprising allowing the activated epoxy nanocomposite to set before applying another layer.

9. The method of claim 1, comprising:
mixing a polyol component with microparticles to form a composite polyol; and
mixing the composite polyol with a diisocyanate to form the polyurethane-composite reaction mixture.

10. The method of claim 9, comprising mixing about 3 to about 20 wt. % of the microparticles with the polyol component to form the composite polyol.

11. The method of claim 1, comprising applying the polyurethane-composite reaction mixture with a sprayer.

12. The method of claim 1, comprising applying the polyurethane-composite reaction mixture with a doctor blade.

13. The method of claim 1, comprising applying the polyurethane-composite reaction mixture at a thickness of about 1 mm to about 2 mm.

14. The method of claim 1, comprising applying multiple layers of the polyurethane-composite reaction mixture over the activated epoxy nanocomposite, allowing each layer to set before applying another layer to reach a thickness of about 1 mm to about 2 mm.

15. A multilayer concrete sealant, comprising:
a first layer disposed over a concrete surface, wherein the first layer comprises an epoxy nanocomposite; and
a second layer disposed over the epoxy nanocomposite, wherein the second layer comprises a polyurethane microcomposite.

16. The multilayer concrete sealant of claim 15, wherein the epoxy nanocomposite comprises less than about 5 wt. % of nanoparticles.

17. The multilayer concrete sealant of claim 16, wherein the nanoparticles comprise silicon dioxide.

18. The multilayer concrete sealant of claim 16, wherein the nanoparticles are between about 10 nm and about 500 nm in size.

19. The multilayer concrete sealant of claim 15, wherein the polyurethane microcomposite comprises between about 3 wt. % and about 20 wt. % of microparticles.

20. The multilayer concrete sealant of claim 19, wherein the microparticles comprise basalt.

21. The multilayer concrete sealant of claim 19, wherein the microparticles are between about 1 and 100 μm.

22. The multilayer concrete sealant of claim 19, wherein the microparticles have an average particle size of 20 μm.
